(19) United States
(12) Patent Application Publication
(10) Pub. No.: US 2026/0274220 A1
(43) Pub. Date: Sep. 17, 2026

(54) METHOD AND APPARATUS FOR AUTOMATIC ASSIGNMENT OF BWCU ID IN EMB SYSTEM

(71) Applicant: HYUNDAI MOBIS CO., LTD., Seoul (KR)

(72) Inventor: DO KUN KIM, Yongin-si (KR)

(73) Assignee: HYUNDAI MOBIS CO., LTD., Seoul (KR)

(21) Appl. No.: 19/349,158

(22) Filed: Oct. 3, 2025

(30) Foreign Application Priority Data
Mar. 17, 2025 (KR) 10-2025-0034127

(51) Int. Cl. B60T 8/172; B60T 13/74; B60T 17/22

(52) U.S. Cl. CPC B60T 8/172; B60T 13/74; B60T 17/22; B60T 2270/82

(57) ABSTRACT

A method and apparatus for automatic assignment of an ID of a BWCU in an EMB system. An aspect of the present disclosure provides an Identifier (ID) assignment controller for a brake wheel controller in a brake system including a first caliper, a second caliper, a third caliper, and a fourth caliper, wherein two calipers among the first to fourth calipers are configured to generate a first local communication signal, the other two calipers are configured to generate a second local communication signal, each of the first to fourth calipers is provided with two output terminals with one of the two output terminals being grounded, wherein the brake wheel controller is mounted on one caliper among the first to fourth calipers, connected to a first output terminal and a second output terminal of the one caliper, and configured to receive one local communication signal between the first local communication signal and the second local communication signal, the ID assignment controller comprising: a processor configured to: acquire the one local communication signal; receive at least one terminal signal received from at least one of the first output terminal or the second output terminal; identify a mounting position of the brake wheel controller based on the one local communication signal and the at least one terminal signal and determine a brake wheel control unit (BWCU) ID of the brake wheel controller based on the mounting position; and control assignment of the BWCU ID to the brake wheel controller based on the determination so that the brake wheel controller controls communication with a plurality of local communication terminals based on the BWCU ID.

### CROSS-REFERENCE TO RELATED APPLICATIONS

This application claims the benefit of and priority to Korean Patent Application No. 10-2025-0034127, filed on Mar. 17, 2025, the entire disclosure(s) of which is hereby incorporated herein by reference in its entirety.

### TECHNICAL FIELD

The present disclosure relates to a method and apparatus for automatic assignment of an ID of a BWCU in an EMB system.

### BACKGROUND

The statements in this section merely provide background information related to the present disclosure and do not necessarily constitute prior art.

A Brake By Wire system such as an electro-mechanical brake (EMB) system includes four EMB calipers and four brake wheel control units (BWCUs) physically spaced apart from each other in a vehicle.

That is, the EMB system includes four EMB calipers and four BWCUs such as a front-left (FL) EMB caliper adjacent to an FL brake pad of the vehicle and an FL BWCU connected thereto, a front-right (FR) EMB caliper adjacent to an FR brake pad of the vehicle and an FR BWCU connected thereto, a rear-left (RL) EMB caliper adjacent to an RL brake pad of the vehicle and an RL BWCU connected thereto, and a rear-right (RR) EMB caliper adjacent to an RR brake pad of the vehicle and an RR BWCU connected thereto.

Each EMB caliper includes a motor, a mechanical conversion device, and a sensor.

The motor of the EMB caliper functions to generate force that pushes the brake pad against a disc.

In the EMB caliper, the mechanical conversion device functions to convert a rotational motion of the motor into a linear motion to move the brake pad linearly.

The sensor mounted on the EMB caliper monitors a brake state (a position of the pad, rotation speed of the disc, temperature, or the like) and transmits a corresponding signal to a relevant controller.

The four BWCUs calculate required braking force and control the motor based on a signal received from a central control unit (ECU) of the vehicle.

The four BWCUs use the same control hardware and the same software, except that each BWCU is assigned a different identifier (ID).

When the EMB system is mounted on the vehicle, each BWCU must be assigned a corresponding ID according to its mounting position in order for the EMB system to operate normally.

In order for a controller controlling the four EMB calipers to identify each BWCU, such as the FL BWCU, the FR BWCU, the RL BWCU, and the RR BWCU during a braking control of the vehicle, a method in which an ID of each BWCU is manually written into an electrically erasable programmable read-only memory (EEPROM) in the BWCU is used in the related art.

However, the method of manually assigning an ID to each BWCU requires a separate work process for assigning the ID to each BWCU after the EMB system is assembled, which may burden a vehicle manufacturing process. Further, if an incorrect ID is assigned to a BWCU due to a worker's mistake, a problem occurs in which the EMB system does not operate normally even though the BWCU functions normally.

### SUMMARY

An object of the present disclosure is to provide a method and apparatus for automatic assignment of an ID of a BWCU in an EMB system.

The technical objects of the present disclosure are not limited to those described above, and other technical objects not mentioned above may be understood clearly by those skilled in the art from the descriptions given below.

An embodiment of the present disclosure provides an Identifier (ID) assignment controller for a brake wheel controller in a brake system including a first caliper, a second caliper, a third caliper, and a fourth caliper, wherein two calipers among the first to fourth calipers are configured to generate a first local communication signal, the other two calipers are configured to generate a second local communication signal, each of the first to fourth calipers is provided with two output terminals with one of the two output terminals being grounded, wherein the brake wheel controller is mounted on one caliper among the first to fourth calipers, connected to a first output terminal and a second output terminal of the one caliper, and configured to receive one local communication signal between the first local communication signal and the second local communication signal, the ID assignment controller comprising: a processor configured to: acquire the one local communication signal; receive at least one terminal signal received from at least one of the first output terminal or the second output terminal; identify a mounting position of the brake wheel controller based on the one local communication signal and the at least one terminal signal and determine a brake wheel control unit (BWCU) ID of the brake wheel controller based on the mounting position; and control assignment of the BWCU ID to the brake wheel controller based on the determination so that the brake wheel controller controls communication with a plurality of local communication terminals based on the BWCU ID.

Another embodiment of the present disclosure provides a method of assigning an Identifier (ID) in a brake wheel controller in a brake system including a first caliper, a second caliper, a third caliper, and a fourth caliper, wherein two calipers among the first to fourth calipers are configured to generate a first local communication signal, the other two calipers are configured to generate a second local communication signal, each of the first to fourth calipers is provided with two output terminals with one of the two output terminals being grounded, wherein the brake wheel controller is mounted on one caliper among the first to fourth calipers, connected to a first output terminal and a second output terminal of the one caliper, and configured to receive one local communication signal between the first local communication signal and the second local communication signal, the method comprising: acquiring the one local communication signal; receiving at least one terminal signal received from at least one of the first output terminal or the second output terminal; and identifying a mounting position of the brake wheel controller based on the one local communication signal and the at least one terminal signal, and determining a brake wheel control unit (BWCU) ID of the brake wheel controller based on the mounting position.

According to an embodiment of the present disclosure, since an ID of each BWCU is automatically assigned after the EMB system is assembled in the vehicle, it is possible to simplify the manufacturing process of the BWCU and prevent human errors that may occur when a worker manually assigns the ID.

Further, since it is not necessary to separately manage the ID depending on a mounting position of the BWCU, it is not necessary to individually manage the BWCU depending on the mounting position, thereby making it possible to manage a total number of manufactured BWCUs in an integrated manner, reduce related logistics costs, and improve productivity.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 is a block diagram illustrating a configuration of a braking system according to an embodiment of the present disclosure.

FIG. 2 is a diagram illustrating a shape of one of a plurality of calipers 110, 120, 130, and 140 on which the brake wheel control device according to the present embodiment is mounted and a state in which the brake wheel control device according to the present embodiment is mounted on the caliper.

FIG. 3 is a functional block diagram illustrating a configuration of an ID assignment device 300 according to an embodiment of the present disclosure.

FIG. 4 is a diagram illustrating an internal configuration of a control circuit 350.

FIG. 5 is a block diagram illustrating a method of assigning an ID according to an embodiment of the present disclosure.

FIG. 6 is a block diagram illustrating an exemplary computing device that may be used for implementing a method or an apparatus according to the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

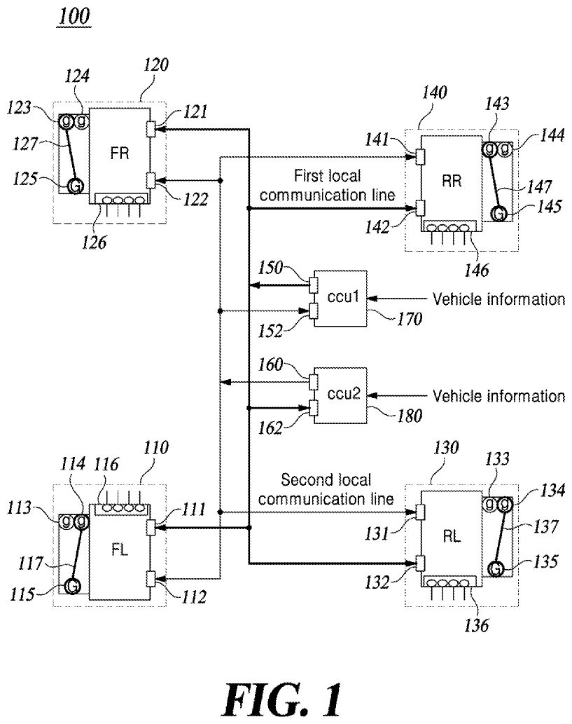

FIG. 1 is a block diagram illustrating a configuration of a braking system according to an embodiment of the present disclosure.

A braking system 100 according to the present embodiment includes a first caliper 110, a second caliper 120, a third caliper 130, a fourth caliper 140, a first connection portion 150, a second connection portion 160, a first center control unit (CCU) 170, and a second CCU 180. In some embodiments, the first CCU 170 and the second CCU 180 may be referred to as a first central controller and a second central controller.

The braking system 100 is configured so that a first local communication signal is generated from any two of the first to fourth calipers 110, 120, 130, and 140, and a second local communication signal is generated from the other two calipers of the first to fourth calipers 110, 120, 130, and 140.

In the present embodiment, various vehicle communication protocols such as a Controller Area Network (CAN), FlexRay, and Local Interconnect Network (LIN) may be used as protocol for local communication.

Further, in the braking system 100, two output terminals are formed for each of the first to fourth calipers, and one of the two output terminals is configured to be grounded and the other output terminal is configured to be not grounded.

The first caliper 110 includes an 11th local communication terminal 111, a 12th local communication terminal 112, an 11th output terminal 113, a 12th output terminal 114, and a first BWCU connector 116.

The second caliper 120 includes a 21st local communication terminal 121, a 22nd local communication terminal 122, a 21st output terminal 123, a 22nd output terminal 124, and a second BWCU connector 126.

The third caliper 130 includes a 31st local communication terminal 131, a 32nd local communication terminal 132, a 31st output terminal 133, a 32nd output terminal 134, and a third BWCU connector 136.

The fourth caliper 140 includes a 41st local communication terminal 141, a 42nd local communication terminal 142, a 41st output terminal 143, a 42nd output terminal 144, and a fourth BWCU connector 146.

The first connection portion 150 is connected to the 11th local communication terminal 111, the 21st local communication terminal 121, the 32nd local communication terminal 132, and the 42nd local communication terminal 142.

The second connection portion 160 is connected to the 12th local communication terminal 112, the 22nd local communication terminal 122, the 31st local communication terminal 131, and the 41st local communication terminal 141.

The 12th output terminal 114, the 21st output terminal 123, the 32nd output terminal 134, and the 41st output terminal 143 are configured to be grounded.

Here, in order to ground the 12th output terminal 114, the 21st output terminal 123, the 32nd output terminal 134, and the 41st output terminal 143, wirings 117, 127, 137, and 147 are formed to connect the 12th output terminal 114, the 21st output terminal 123, the 32nd output terminal 134, and the 41st output terminal 143 to corresponding ground terminals 115, 125, 135, and 145.

The ground terminals 115, 125, 135, and 145 may be configured to be connected to a chassis of the vehicle, but is not limited thereto, and the ground terminals 115, 125, 135, and 145 may be grounded in various ways.

Further, the 11th output terminal 113, the 22nd output terminal 124, the 31st output terminal 133, and the 42nd output terminal 144 are formed not to be grounded.

For example, the 11th output terminal 113, the 22nd output terminal 124, the 31st output terminal 133, and the 42nd output terminal 144 are configured to be electrically open not to be grounded.

The first BWCU connecting connector 116 includes, as fastening means, four connection pins respectively connected to the 11th local communication terminal 111, the 12th local communication terminal 112, the 11th output terminal 113, and the 12th output terminal 114.

The second BWCU connecting connector 126 includes, as fastening means, four connection pins respectively connected to the 21st local communication terminal 121, the 22nd local communication terminal 122, the 21st output terminal 123, and the 22nd output terminal 124.

The third BWCU connecting connector 136 includes, as fastening means, four connection pins respectively connected to the 31st local communication terminal 131, the 32nd local communication terminal 132, the 31st output terminal 133, and the 32nd output terminal 134.

The fourth BWCU connecting connector 146 includes, as fastening means, four connection pins respectively connected to the 41st local communication terminal 141, the 42nd local communication terminal 142, the 41st output terminal 143, and the 42nd output terminal 144.

The first CCU 170 is connected to the first connection unit 150 to generate a first local communication signal including a first preset ID and transmit the first local communication signal to the first and second calipers 110 and 120. That is, the first CCU 170 transmits the first local communication signal including the first preset ID to the respective local communication terminals 111 and 121 of the first and second calipers 110 and 120 through the first local communication line.

The second CCU 180 is connected to the second connection unit 160 to generate the second local communication signal including a second preset ID and transmit the second local communication signal to the third and fourth calipers 130 and 140. That is, the second CCU 180 transmits the second local communication signal including the second preset ID to the respective local communication terminals 131 and 141 of the third and fourth calipers 130 and 140 through the second local communication line.

Here, the first preset ID and the second preset ID have different values.

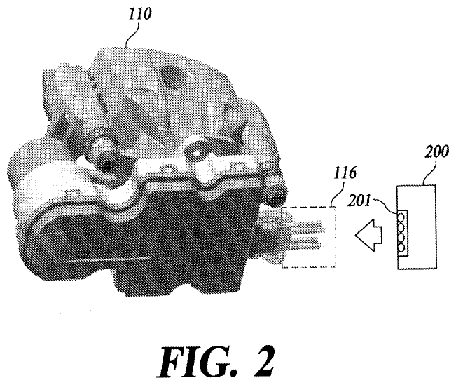

FIG. 2 is a diagram illustrating a shape of one of a plurality of calipers 110, 120, 130, and 140 on which the brake wheel control device according to the present embodiment is mounted, and a state in which the brake wheel control device according to the present embodiment is mounted on the caliper.

In FIG. 2, a case in which a brake wheel control device 200 according to the present embodiment is mounted on the first caliper 110 is illustrated.

The brake wheel control device 200 is mounted on one of the first to fourth calipers 110, 120, 130, and 140, is connected to the first output terminal and the second output terminal of the caliper, and is configured to receive one of the first local communication signal and the second local communication signal. In some embodiments, the brake wheel control device 200 may be referred to as the brake wheel controller 200. In some embodiments, the brake wheel control device 200 may be referred to as the brake wheel control unit (BWCU) 200.

When the brake wheel control device 200 is mounted on one caliper, a power supply is supplied to the mounted brake wheel control device 200 so that booting starts. During a booting process of the brake wheel control device 200, the first CCU 170 is controlled to generate the first local communication signal including the first preset ID, and the second CCU 180 is controlled to generate the second local communication signal including the second preset ID.

For reference, the booting means a state in which an operation of loading software related to the brake wheel control device 200 into a memory of the brake wheel control device 200 and reading and storing setting values related to an operation of the software in the memory is completed so that the brake wheel control device 200 can perform a normal operation (that is, an braking operation for a brake at a corresponding position).

The brake wheel control device 200 according to the present embodiment is configured to be mountable on any of the first caliper 110, the second caliper 120, the third caliper 130, and the fourth caliper 140.

The brake wheel control device 200 includes a BWCU connection portion 201 configured to be connectable to each of the first BWCU connecting connector 116, the second BWCU connecting connector 126, the third BWCU connecting connector 136, and the fourth BWCU connecting connector 146.

The BWCU connection portion 201 includes four fastening means corresponding to and connectable to the four connecting pins of any one of the first BWCU connecting connector 116, the second BWCU connecting connector 126, the third BWCU connecting connector 136, and the fourth BWCU connecting connector 146.

Therefore, the brake wheel control device 200 is mounted on the corresponding caliper by being connected to any one of the first BWCU connecting connector 116, the second BWCU connecting connector 126, the third BWCU connecting connector 136, and the fourth BWCU connecting connector 146.

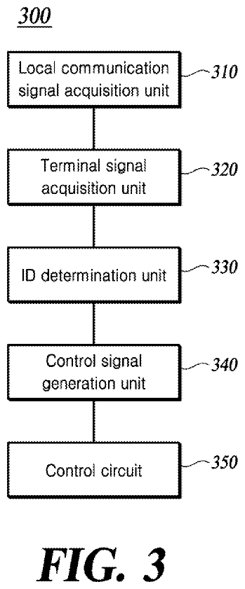

That is, the brake wheel control device 200 is mounted on one caliper in this way so that the brake wheel control device 200 can be connected to the first output terminal and the second output terminal of the caliper and can receive one of the first local communication signal and the second local communication signal FIG. 3 is a functional block diagram illustrating a configuration of the Identifier (ID) assignment device 300 according to an embodiment of the present disclosure.

The ID assignment device 300 according to the present embodiment is implemented in the brake wheel control device 200. In some embodiments, the ID assignment device 300 may be referred to as an ID assignment controller 300.

The ID assignment device 300 according to the present embodiment may be implemented to include a local communication signal acquisition unit 310, a terminal signal acquisition unit 320, an ID determination unit 330, a control signal generation unit 340, and a control circuit 350. The ID assignment device 300 according to the present embodiment may be implemented without some of the components in FIG. 3 or implemented with other added components not illustrated in FIG. 3.

In the following description, the brake wheel control device 200 is assumed to be mounted on the first caliper 110 among the first caliper 110, the second caliper 120, the third caliper 130, and the fourth caliper 140, unless otherwise stated.

The local communication signal acquisition unit 310 acquires the local communication signal from the preset local communication terminal 111, 121, 131, or 141 of the caliper 110, 120, 130, or 140 on which the brake wheel control device 200 is mounted.

In the braking system 100, main local communication terminals 111, 121, 131, and 141 and sub local communication terminals 112, 122, 132, and 142 are set, and the local communication signal acquisition unit 310 is configured to acquire the local communication signal from the main local communication terminals 111, 121, 131, and 141.

Therefore, when the brake wheel control device 200 is mounted on the first caliper 110, the local communication signal acquisition unit 310 acquires the local communication signal from the 11th local communication terminal 111.

The local communication signal acquisition unit 310 acquires a CCU identification ID included in the local communication signal from the acquired local communication signal.

The terminal signal acquisition unit 320 receives a terminal signal from at least one of the two output terminals 113 and 114 included in the first caliper 110 on which the brake wheel control device 200 is mounted.

Here, the following description is given assuming that the one output terminal is the 11th output terminal 113 and the other output terminal is the 12th output terminal 114.

Accordingly, the terminal signal acquisition unit 320 acquires one of the first terminal signal and the second terminal signal as a logic high value and acquires the other of the first terminal signal and the second terminal signal as a logic low value.

The terminal signal acquisition unit 320 may acquire both the first terminal signal and the second terminal signal, but since the first terminal signal and the second terminal signal have different preset values, the terminal signal acquisition unit 320 may determine the value of the other terminal signal to be the different preset value when acquiring the value of the one terminal signal.

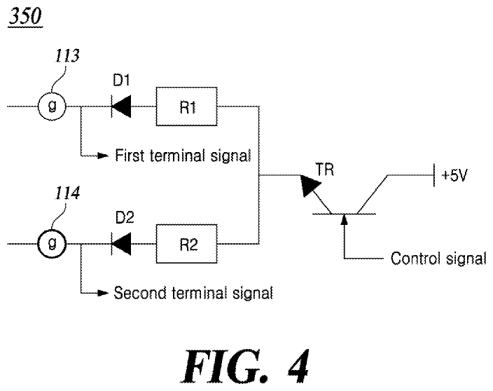

FIG. 4 is a diagram illustrating an internal configuration of the control circuit 350.

The control circuit 350 includes a first series circuit including a first diode D1 and a first resistor R1 connected in series with each other, a second series circuit including a second diode D2 and a second resistor R2 connected in series with each other, and a switch element TR.

One end of the first series circuit is connected to one output terminal (that is, the 11th output terminal 113), one end of the second series circuit is connected to the other output terminal (that is, the 12th output terminal 114), the other end of the first series circuit is connected to one end of the switch element TR, and the other end of the switch element TR is connected to a power supply (+5 V).

According to the embodiment, D1 and D2 may be omitted and, in this case, the first series circuit includes the first resistor R1 and the second series circuit includes the second resistor R2.

The control signal generation unit 340 generates a control signal for turning ON the switch element TR in order to receive the first terminal signal and the second terminal signal.

During the booting process of the brake wheel control device 200, the control signal generation unit 340 is controlled to generate a control signal and turn ON or OFF the switch element TR.

When the control signal generation unit 340 sets the control signal to high, the switch element TR is turned ON, and when the control signal is set to low, the switch element TR is turned OFF.

When the switch element TR is turned on by the control signal, current flows from the power supply (+5 V) to the 12th output terminal 114, so that the second terminal signal detected at the 12th output terminal 114 is a low signal. However, since no current flows from the power supply (+5 V) to the 11th output terminal 113, the first terminal signal detected at the 11th output terminal 113 is a high signal.

The ID determination unit 330 identifies a mounting position (for example, the first caliper 110) of the brake wheel control device 200 based on the local communication signal and at least one terminal signal, and determines a BWCU ID of the brake wheel control device 200 based on the identified mounting position.

The ID determination unit 330 identifies the mounting position of the brake wheel control device 200 using a method (that is, a first determination method) in which the CCU identification ID is used.

The identification of the mounting position of the brake wheel control device 200 means identifying which of the first to fourth calipers the brake wheel control device 200 is mounted on.

For example, when the CCU identification ID is 10, the ID determination unit 330 recognizes that the mounting position of the brake wheel control device 200 is in a front direction of the vehicle, and therefore, determines that the corresponding mounting caliper is the first caliper 110 which is a caliper on the front left (FL) side or the second caliper 120 which is a caliper on the front right (FR) side.

Further, when the CCU identification ID is 20, the ID determination unit 330 recognizes that the mounting position of the corresponding brake wheel control device 200 is in a rear direction of the vehicle, and therefore, determines that the corresponding mounting caliper is the third caliper 130 which is a caliper on the rear left (RL) side or the fourth caliper 140 which is a caliper on the rear right (RR) side.

The ID determination unit 330 identifies the mounting position of the brake wheel control device 200 by using a method (that is, a second determination method) in which whether at least one terminal signal is logic high or logic low is used.

For example, when the first terminal signal is high and the second terminal signal is low, the mounting position of the brake wheel control device 200 is recognized as being on the left side of the vehicle, and the corresponding caliper is determined to be the first caliper 110 which is the caliper on the front left (FL) side or the third caliper 130 which is the caliper on the rear left (RL) side.

Therefore, in this case, the ID determination unit 330 determines that the mounting position is in a front direction of the vehicle when the CCU identification ID is 10 using the first determination method, determines that the mounting position is in a left direction of the vehicle when the first terminal signal is high and the second terminal signal is low using the second determination method, and determines that the caliper corresponding to an intersection position in the two determination methods is a front left caliper. Therefore, the FL caliper 110, which is the front left caliper, becomes the mounting position of the brake wheel control device 200.

Thus, the ID determination unit 330 uses the CCU identification ID and at least one terminal signal to determine on which of the first to fourth calipers 110, 120, 130, and 140 in the vehicle the corresponding brake wheel control device 200 is mounted, checks a preset BWCU ID corresponding to each mounting position, and store the BWCU ID corresponding to the mounting position of the brake wheel control device 200 in the brake wheel control device 200.

When the BWCU ID is stored in the brake wheel control device 200 and the booting of the brake wheel control device is ended, the brake wheel control device 200 controls braking using communication signals received from different local communication terminals in the brake wheel control device 200 according to the BWCU ID.

When the brake wheel control device 200 is mounted on the first caliper 110, the second caliper 120, the third caliper 130, and the fourth caliper 140, the assignable BWCU IDs are set to FL, FR, RL, and RR, respectively.

When the BWCU ID is FL or FR, the brake wheel control device 200 receives the local communication signal from the main local communication terminals 111 and 121 and controls the brake braking at the corresponding position.

When the BWCU ID is RL or RR, the brake wheel control device 200 receives the local communication signal from the sub local communication terminals 132 and 142 and controls the brake braking at the corresponding position.

For example, the first CCU 170 receives various types of information within the vehicle from devices such as sensors inside the vehicle, and transmits a command for controlling the braking of the vehicle to each brake wheel control device through the first communication line.

Here, each brake wheel control device means a brake wheel control device that is mounted on each of the first to fourth calipers 110, 120, 130, and 140 to control the braking of the wheel corresponding to the mounting position.

As described above, each of the calipers 110, 120, 130, and 140 includes a motor, a mechanical conversion device, and a sensor to perform brake control of the wheel corresponding to the mounting position.

Meanwhile, the use of two local communication terminals for each of the calipers 110, 120, 130, and 140 is intended to use another communication line when an error occurs in transmission and reception of data through one communication line. Since details regarding this are outside the gist of the present invention, further description thereof will be omitted.

Further, the fact that the first CCU 170 is connected to the two connection portions 150 and 152 and the second CCU 180 is connected to the two other connection portions 160 and 162 is also intended to use the other communication line when an error occurs in the transmission and reception of data through the one communication line, and since details regarding this are outside the gist of the present invention, further description thereof will be omitted.

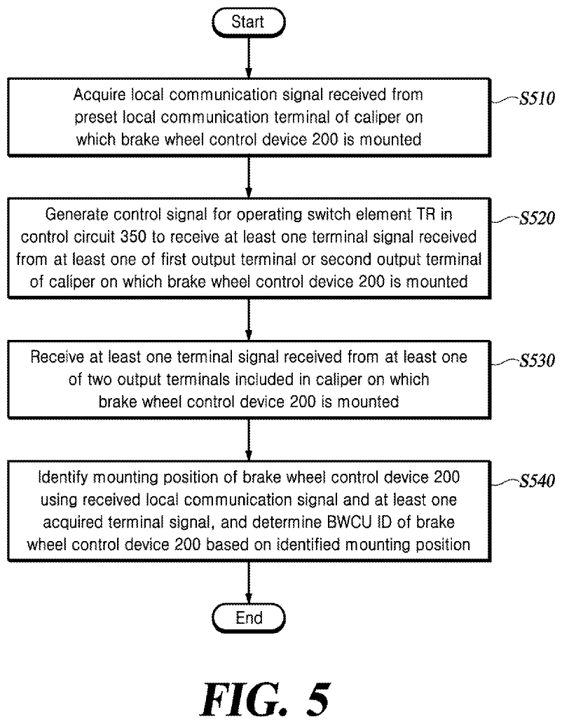

FIG. 5 is a block diagram illustrating a method of assigning an ID according to an embodiment of the present disclosure.

The method of assigning an ID according to an embodiment of the present disclosure is performed by the ID assignment device 300.

The local communication signal acquisition unit 310 performs a local communication signal acquisition process of acquiring the local communication signal received from the preset local communication terminal of the caliper on which the brake wheel control device 200 is mounted (S510).

The control signal generation unit 340 performs a control signal generation process for generating a control signal for operating the switch element TR in the control circuit 350 to receive at least one terminal signal received from at least one of the first output terminal or the second output terminal of the caliper on which the brake wheel control device 200 is mounted (S520).

The terminal signal acquisition unit 320 performs a terminal signal acquisition process for receiving at least one terminal signal received from at least one of the two output terminals included in the caliper on which the brake wheel control device 200 is mounted (S530).

The ID determination unit 330 identifies the mounting position of the brake wheel control device 200 using the received local communication signal and the at least one acquired terminal signal, and performs an ID determination process of determining the BWCU ID of the brake wheel control device 200 based on the identified mounting position (S540).

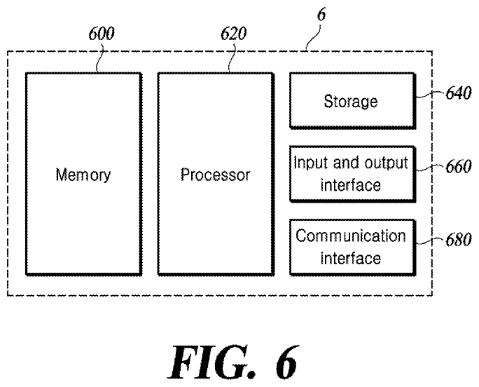

FIG. 6 is a block diagram illustrating an exemplary computing device that may be used for implementing a method or an apparatus according to the present disclosure.

The computing device 60 may include all or part of a memory 600, a processor 620, a storage 640, an input/output interface 660, and a communication interface 680. The computing device 60 may be a stationary computing device, such as a desktop computer or a server, or a mobile computing device, such as a laptop computer or a smart phone. The computing device 60 may include a specialized hardware accelerator capable of processing operations of an artificial intelligence model in an efficient manner. For example, the computing device 60 may include a graphic processing unit (GPU), a tensor processing unit (TPU), or a neural processing unit (NPU).

The memory 600 may store a program that enables the processor 620 to perform methods or operations according to various embodiments of the present disclosure. For example, a program may include a plurality of instructions executable by the processor 620, and the methods or operations described above may be performed by executing the plurality of instructions by the processor 620. The memory 600 may consist of a single memory or a plurality of memories. In this case, information required to perform the methods or operation according to various embodiments of the present disclosure may be stored in a single memory or distributed across a plurality of memories. When the memory 600 is composed of a plurality of memories, the plurality of memories may be physically separated. The memory 600 may include at least one of volatile memory and non-volatile memory. Volatile memory includes Static Random Access Memory (SRAM) or Dynamic Random Access Memory (DRAM), while non-volatile memory includes flash memory.

The processor 620 may include at least one core capable of executing at least one instruction. The processor 620 may execute instructions stored in the memory 600. The processor 620 may consist of a single processor or a plurality of processors.

The storage 640 maintains stored data even if power supplied to the computing device 60 is cut off. For example, the storage 640 may include non-volatile memory or may include a storage medium such as a magnetic tape, an optical disk, or a magnetic disk. A program stored in the storage 640 may be loaded into the memory 600 before being executed by the processor 620. The storage 640 may store files written in a program language, and a program created from the files by a compiler may be loaded into the memory 600. The storage 640 may store data to be processed by the processor 620 and/or data processed by the processor 620.

The input/output interface 660 may provide an interface with an input device such as a keyboard or a mouse and/or an output device such as a display device or a printer. The user may trigger execution of a program by the processor 620 through the input device and/or check the processing results of the processor 620 through the output device.

The communication interface 680 may provide access to an external network. The computing device 60 may communicate with other devices through the communication interface 680.

According to an exemplary embodiment of the present disclosure, the ID assignment device 300 may include the processor 620 and the memory 600 storing software instructions which, when executed by the processor, provides the functionalities of the local communication signal acquisition unit 310, the terminal signal acquisition unit 320, the ID determination unit 330 and the control signal generation unit 340. Herein, the memory and the processor may be implemented as separate semiconductor circuits. Alternatively, the memory and the processor may be implemented as a single integrated semiconductor circuit. The processor may embody one or more processor(s).

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed:

1. An Identifier (ID) assignment controller for a brake wheel controller in a brake system including a first caliper, a second caliper, a third caliper, and a fourth caliper, wherein two calipers among the first to fourth calipers are configured to generate a first local communication signal, the other two calipers are configured to generate a second local communication signal, each of the first to fourth calipers is provided with two output terminals with one of the two output terminals being grounded, wherein the brake wheel controller is mounted on one caliper among the first to fourth calipers, connected to a first output terminal and a second output terminal of the one caliper, and configured to receive one local communication signal between the first local communication signal and the second local communication signal, the ID assignment controller comprising:
a processor configured to: acquire the one local communication signal;
receive at least one terminal signal received from at least one of the first output terminal or the second output terminal;
identify a mounting position of the brake wheel controller based on the one local communication signal and the at least one terminal signal and determine a brake wheel control unit (BWCU) ID of the brake wheel controller based on the mounting position; and
control assignment of the BWCU ID to the brake wheel controller based on the determination so that the brake wheel controller controls communication with a plurality of local communication terminals based on the BWCU ID.

2. The ID assignment controller of claim 1, wherein the processor identifies which one of the first to fourth calipers the one caliper corresponds to, to identify the mounting position.

3. The ID assignment controller of claim 1,
wherein the first caliper includes an 11th local communication terminal and a 12th local communication terminal, and two output terminals including an 11th output terminal and a 12th output terminal,
the second caliper includes a 21st local communication terminal and a 22nd local communication terminal, and two output terminals including a 21st output terminal and a 22nd output terminal,
the third caliper includes a 31st local communication terminal and a 32nd local communication terminal, and two output terminals including a 31st output terminal and a 32nd output terminal,
the fourth caliper includes a 41st local communication terminal and a 42nd local communication terminal, and two output terminals including a 41st output terminal and a 42nd output terminal, and
the braking system further includes
a first central controller configured to generate the first local communication signal including a first preset ID to the 11th local communication terminal and the 21st local communication terminal; and
a second central controller configured to generate the second local communication signal including a second preset ID to the 31st local communication terminal and the 41st local communication terminal.

4. The ID assignment controller of claim 3, wherein, during a booting process of the brake wheel controller when the brake wheel controller is mounted on the one caliper, the first central controller is controlled to generate the first local communication signal including a first preset ID, and the second central controller is controlled to generate the second local communication signal including a second preset ID.

5. The ID assignment controller of claim 4, wherein, after the booting process of the brake wheel controller ends, the brake wheel controller controls a braking of a vehicle using signals received from different local communication terminals according to the BWCU ID.

6. The ID assignment controller of claim 1,
wherein the processor acquires a central control unit (CCU) identification ID from the local communication signal, and
identifies the mounting position using the CCU identification ID.

7. The ID assignment controller of claim 1, further comprising:
a first series circuit including a first diode and a first resistor connected in series with each other;
a second series circuit including a second diode and a second resistor connected in series with each other;
a control circuit including a switch element; and
the processor further configured to generate a control signal for operating the switch element to receive the at least one terminal signal,
wherein one end of the first series circuit is connected to one output terminal between the first output terminal and the second output terminal, one end of the second series circuit is connected to the other output terminal, the other end of the first series circuit is connected to one end of the switch element, and a power supply is connected to the other end of the switch element.

8. The ID assignment controller of claim 1,
wherein the braking system further includes
a first BWCU connecting connector including a plurality of fastening means connected to a 11th local communication terminal, a 12th local communication terminal, a 11th output terminal, and a 12th output terminal;
a second BWCU connecting connector including a plurality of fastening means connected to a 21st local communication terminal, a 22nd local communication terminal, a 21st output terminal, and a 22nd output terminal;
a third BWCU connecting connector including a plurality of fastening means connected to a 31st local communication terminal, a 32nd local communication terminal, a 31st output terminal, and a 32nd output terminal; and
a fourth BWCU connecting connector including a plurality of fastening means connected to a 41st local communication terminal, a 42nd local communication terminal, a 41st output terminal, and a 42nd output terminal, and
the brake wheel controller includes a BWCU connection portion configured to be connectable to the first to fourth BWCU connecting connectors.

9. A method of assigning an Identifier (ID) in a brake wheel controller in a brake system including a first caliper, a second caliper, a third caliper, and a fourth caliper, wherein two calipers among the first to fourth calipers are configured to generate a first local communication signal, the other two calipers are configured to generate a second local communication signal, each of the first to fourth calipers is provided with two output terminals with one of the two output terminals being grounded, wherein the brake wheel controller is mounted on one caliper among the first to fourth calipers, connected to a first output terminal and a second output terminal of the one caliper, and configured to receive one local communication signal between the first local communication signal and the second local communication signal, the method comprising:
acquiring the one local communication signal;
receiving at least one terminal signal received from at least one of the first output terminal or the second output terminal; and
identifying a mounting position of the brake wheel controller based on the one local communication signal and the at least one terminal signal, and determining a brake wheel control unit (BWCU) ID of the brake wheel controller based on the mounting position.

10. The method of assigning an ID of claim 9, wherein identifying the mounting position comprises identifying which one of the first to fourth calipers the one caliper corresponds to, to identify the mounting position.

11. The method of assigning an ID of claim 9,
wherein the first caliper includes an 11th local communication terminal and a 12th local communication terminal, and two output terminals including an 11th output terminal and a 12th output terminal,
the second caliper includes a 21st local communication terminal and a 22nd local communication terminal, and two output terminals including a 21st output terminal and a 22nd output terminal,
the third caliper includes a 31st local communication terminal and a 32nd local communication terminal, and two output terminals including a 31st output terminal and a 32nd output terminal,
the fourth caliper includes a 41st local communication terminal and a 42nd local communication terminal, and two output terminals including a 41st output terminal and a 42nd output terminal, and
the braking system includes
a first central controller configured to generate the first local communication signal including a first preset ID to the 11th local communication terminal and the 21st local communication terminal; and
a second central controller configured to generate the second local communication signal including a second preset ID to the 31st local communication terminal and the 41st local communication terminal.

12. The method of assigning an ID of claim 11, wherein, during a booting process of the brake wheel controller when the brake wheel controller is mounted on the one caliper, the first central controller is controlled to generate the first local communication signal including a first preset ID, and the second central controller is controlled to generate the second local communication signal including a second preset ID.=

13. The method of assigning an ID of claim 12, wherein, after the booting process of the brake wheel controller ends, the brake wheel controller controls braking of a vehicle using signals received from different local communication terminals according to the BWCU ID.

14. The method of assigning an ID of claim 9,
wherein acquiring the local communication signal comprises acquiring a CCU identification ID from the local communication signal, and
the identifying the mounting position comprises identifying the mounting position using the CCU identification ID.

15. The method of assigning an ID of claim 9,
wherein the brake wheel controller further includes a first series circuit including a first diode and a first resistor connected in series with each other; a second series circuit including a second diode and a second resistor connected in series with each other; and a control circuit including a switch element,
the method further comprises generating a control signal for operating the switch element to receive the at least one terminal signal,
one end of the first series circuit is connected to one output terminal between the first output terminal and the second output terminal, one end of the second series circuit is connected to the other output terminal, the other end of the first series circuit is connected to one end of the switch element, and a power supply is connected to the other end of the switch element.
